(19) United States
(12) Patent Application Publication
(10) Pub. No.: US 2026/0031727 A1
(43) Pub. Date: Jan. 29, 2026

(54) STEP-UP DC/DC CONVERTER AND SEMICONDUCTOR DEVICE

(71) Applicant: ROHM Co., LTD., Kyoto (JP)

(72) Inventor: Masahiro Osa, Kyoto (JP)

(21) Appl. No.: 19/272,484

(22) Filed: Jul. 17, 2025

(30) Foreign Application Priority Data
Jul. 26, 2024 (JP) 2024-120996

(51) Int. Cl. H02M 3/158; H02M 1/32; H02M 3/157

(52) U.S. Cl. CPC H02M 3/158; H02M 1/32; H02M 3/157

(57) ABSTRACT

Provided is a step-up DC/DC converter including an input line configured to allow an input power supply voltage to be applied thereto, an output line configured to allow an output voltage to be applied thereto, a coil connected between the input line and the output line, a load switch connected between the input line and the output line, and a semiconductor device. The semiconductor device includes a voltage monitoring circuit configured to output an abnormal voltage notification signal when a potential difference across the coil exceeds a threshold value, a control circuit configured to control the load switch, based on the abnormal voltage notification signal, and a current control circuit configured to control a current flowing through the coil so as to match the output voltage with a target value.

### CROSS REFERENCE TO RELATED APPLICATIONS

This application claims priority benefit of Japanese Patent Application No. JP 2024-120996 filed in the Japan Patent Office on Jul. 26, 2024. Each of the above-referenced applications is hereby incorporated herein by reference in its entirety.

### BACKGROUND

The present disclosure relates to a step-up direct current/direct current DC/DC converter and a semiconductor device.

In order to operate a device that requires a voltage higher than a power supply voltage, a step-up DC/DC converter (Boost Converter) is used. Due to a configuration of the step-up DC/DC converter, if the power supply voltage is applied in a state of a ground fault of the output, an overcurrent will flow from the power supply to ground (GND) via a coil and a parasitic diode of a high-side switch, which could cause damage to the coil and the high-side switch due to the overcurrent continuing to flow.

In the case where it is desired to prevent an overcurrent from continuing to flow when the output of the step-up DC/DC converter is in a ground fault state, a load switch is provided (see, for example, JP 2022-187421A). In the event of a ground fault, the load switch turns off, preventing an overcurrent from continuing to flow through the output line and preventing damage to the coil and the high-side switch.

### BRIEF DESCRIPTION OF THE DRAWINGS

FIG. 1 is a diagram illustrating a step-up DC/DC converter according to a first embodiment;

FIG. 2 is a diagram illustrating, in detail, a voltage monitoring circuit and a control circuit in FIG. 1;

FIG. 3 is a diagram illustrating a step-up DC/DC converter according to a second embodiment; and

FIG. 4 is a diagram illustrating a step-up DC/DC converter according to a third embodiment.

### DETAILED DESCRIPTION

### First Embodiment

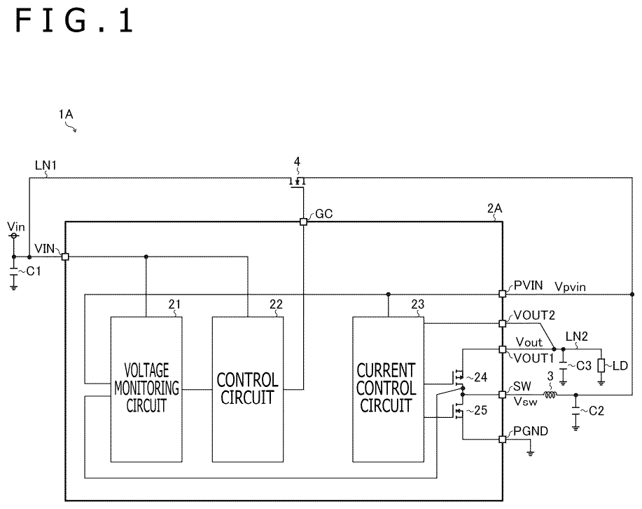

As illustrated in FIG. 1, a step-up DC/DC converter 1A according to the first embodiment includes a semiconductor device 2A, an input line LN1, an output line LN2, a coil 3, a load switch 4, and capacitors C1 to C3.

The semiconductor device 2A has a terminal VIN, terminal PVIN, a terminal SW, a terminal GC, a terminal VOUT1, a terminal VOUT2, and a terminal PGND.

An input power supply voltage Vin is applied to the input line LN1. The input line LN1 is connected to the terminal VIN and the first end of the capacitor C1. The second end of the capacitor C1 is connected to ground.

An output voltage Vout is applied to the output line LN2. The output line LN2 is connected to the terminal VOUT1, the terminal VOUT2, the first end of the capacitor C3, and the first end of a load LD. The second end of the capacitor C3 and the second end of the load LD are grounded.

The coil 3 and the load switch 4 are provided between the input line LN1 and the output line LN2. In the present embodiment, the load switch 4 is a negative-channel metal oxide semiconductor (NMOS) transistor. The drain of the load switch 4 is connected to the input line LN1. The gate of the load switch 4 is connected to the terminal GC. The source of the load switch 4 is connected to the terminal PVIN, the first end of the coil 3, and the first end of the capacitor C2. The second end of the capacitor C2 is grounded. The second end of the coil 3 is connected to the terminal SW. Note that unlike the present embodiment, the load switch 4 may be a switch other than an NMOS transistor.

The terminal VOUT2 is an external terminal for feeding back the output voltage Vout to the semiconductor device 2A. The terminal PGND is grounded.

Next, the internal configuration of the semiconductor device 2A will be described. The semiconductor device 2A includes a voltage monitoring circuit 21, a control circuit 22, a current control circuit 23, a high-side switch 24, and a low-side switch 25.

The voltage monitoring circuit 21 detects the potential difference across the coil 3 from the voltage applied to the terminal PVIN and the voltage applied to the terminal SW, and outputs an abnormal voltage notification signal when the potential difference across the coil 3 exceeds a threshold value.

The control circuit 22 controls the load switch 4 by outputting a control signal to the terminal GC, on the basis of the abnormal voltage notification signal.

The current control circuit 23 controls the duty of the switch voltage Vsw generated at the terminal SW by controlling the drive of the high-side switch 24 and the low-side switch 25, on the basis of the output voltage Vout fed back from the terminal VOUT2. Therefore, the current control circuit 23 controls the current flowing through the coil 3 such that the output voltage Vout output from the terminal VOUT1 coincides with a target value.

The high-side switch 24 is a positive-channel metal oxide semiconductor (PMOS) transistor with the gate connected to the current control circuit 23, the drain connected to the terminal SW and the drain of the low-side switch 25, and the source connected to the terminal VOUT1.

The low-side switch 25 is an NMOS transistor with the gate connected to the current control circuit 23, the source connected to the terminal PGND, and the drain connected to the drain of the high-side switch 24.

Unlike the present embodiment, the high-side switch 24 may be a switch other than a PMOS transistor, and the low-side switch 25 may be a switch other than an NMOS transistor.

The voltage monitoring circuit 21 and the control circuit 22 use the input power supply voltage Vin applied to the terminal VIN as a power supply voltage.

The current control circuit 23 uses the voltage applied to the terminal PVIN as a power supply voltage.

In the step-up DC/DC converter 1A according to the first embodiment illustrated in FIG. 1, if the input power supply voltage Vin is applied when the output is in a ground-fault state, the voltage monitoring circuit 21 detects that the potential difference across the coil 3 increases if an overcurrent flows through the coil 3, and outputs an abnormal voltage notification signal if the potential difference across the coil 3 exceeds a threshold value, and then the control circuit 22 takes control so as to turn the load switch 4 OFF.

As a result, an overcurrent can be prevented from continuing to flow in a ground-fault state of the output of the step-up DC/DC converter 1A according to the first embodiment illustrated in FIG. 1, and by providing the load switch 4 outside the semiconductor device 2A, it is possible to reduce resistance loss and prevent deterioration in efficiency and heat generation.

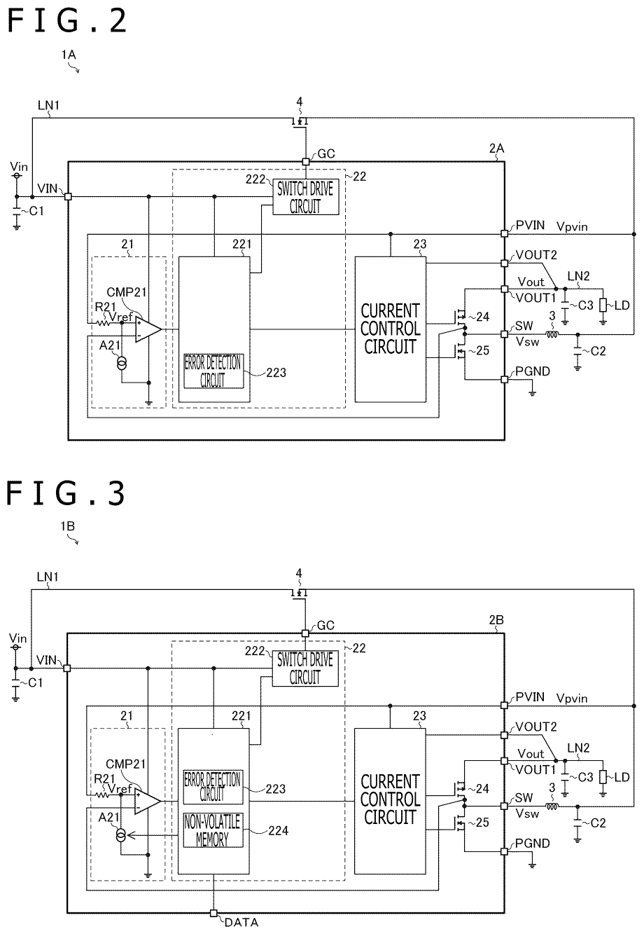

FIG. 2 is a diagram illustrating a specific example of the configuration of the voltage monitoring circuit 21 and the control circuit 22 in the first embodiment.

The voltage monitoring circuit 21 includes a resistor R21, a constant-current source A21, and a comparator CMP21.

The first terminal of the resistor R21 and the first terminal of the constant-current source A21 are connected to the non-inverting input terminal of the comparator CMP21. The terminal SW is connected to the inverting input terminal of the comparator CMP21. The terminal PVIN is connected to the second terminal of the resistor R21. The second terminal of the constant-current source A21 is grounded.

The resistor R21 and the constant-current source A21 are an example of a voltage drop circuit that drops the voltage applied to the terminal PVIN by a threshold value. The comparator CMP21 compares the voltage Vsw from the terminal SW with a voltage Vref obtained by dropping a voltage Vpvin applied from the terminal PVIN by a threshold voltage amount via the resistor R21 and the constant-current source A21. When the voltage Vref exceeds the voltage Vsw, an abnormal voltage notification signal is output.

The voltage Vref is expressed by the following equation. Here, r21 is a resistance value of the resistor R21, and a21 is the current value of the constant current output from the constant-current source A21.

$$Vref = Vpvin - ( r 21 \times a 21 )$$

Here, the abnormal voltage notification signal is applied when the output of the comparator CMP21 is at a high level.

The control circuit 22 includes a logic circuit 221 and a switch drive circuit 222.

The output terminal of the comparator CMP21 is connected to the input terminal of the logic circuit 221.

The output terminal of the logic circuit 221 is connected to the input terminal of the switch drive circuit 222, and the terminal GC is connected to the output terminal of the switch drive circuit 222.

When receiving the abnormal voltage notification signal output from the comparator CMP21, the logic circuit 221 sends a switch control signal for turning the load switch 4 OFF to the switch drive circuit 222.

When receiving the switch control signal output from the logic circuit 221, the switch drive circuit 222 sends a control signal for turning the load switch 4 OFF to the terminal GC.

Once the load switch 4 is turned OFF, the control circuit 22 keeps the load switch 4 OFF. To be specific, once the comparator CMP21 becomes high level and outputs an abnormal voltage notification signal, even if the voltage Vref falls below the voltage Vsw and the comparator CMP21 outputs a low level signal, the control circuit 22 does not switch the load switch 4 from OFF to ON.

The control circuit 22 includes an error detection circuit 223. The control circuit 22 not only detects an overcurrent by checking the potential difference across the coil 3 to turn the load switch 4 OFF, but also turns the load switch 4 OFF when an error detection circuit 223 detects an abnormality other than an overcurrent. Abnormalities other than overcurrent include temperature abnormalities and power supply voltage abnormalities, for example. Note that, unlike the present embodiment, the control circuit 22 may be configured not to have the error detection circuit 223.

### Second Embodiment

FIG. 3 is a diagram illustrating a step-up DC/DC converter 1B according to the second embodiment. The step-up DC/DC converter 1B differs from the step-up DC/DC converter 1A of the first embodiment in that it includes a semiconductor device 2B instead of the semiconductor device 2A, but is otherwise basically similar to the step-up DC/DC converter 1A of the first embodiment. The semiconductor device 2B differs from the semiconductor device 2A in that it includes a non-volatile memory 224 inside the logic circuit 221 and has a terminal DATA, but is otherwise basically similar to the semiconductor device 2A.

The terminal DATA is connected to the logic circuit 221 provided inside the semiconductor device 2B.

The logic circuit 221 includes the non-volatile memory 224 inside. The non-volatile memory 224 stores a setting value of the constant-current source A21.

According to the step-up DC/DC converter 1B according to the second embodiment illustrated in FIG. 3, the setting value of the constant-current source A21 stored in the non-volatile memory 224 can be rewritten by a control signal from the terminal DATA.

This makes it possible for the step-up DC/DC converter 1B according to the second embodiment illustrated in FIG. 3 to adjust the threshold value of the voltage monitoring circuit 21 according to a type, an inductance value, etc., of the external coil 3.

### Third Embodiment

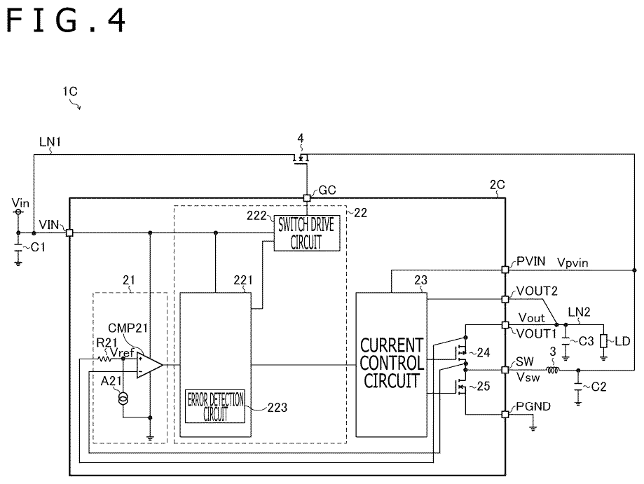

FIG. 4 is a diagram illustrating a step-up DC/DC converter 1C according to the third embodiment. The step-up DC/DC converter 1C differs from the step-up DC/DC converter 1A of the first embodiment in that it includes a semiconductor device 2C instead of the semiconductor device 2A, but is otherwise basically similar to the step-up DC/DC converter 1A of the first embodiment. The semiconductor device 2C differs from the semiconductor device 2A in that the non-inverting input terminal of the comparator CMP21 is connected to the connection node between the high-side switch 24 and the terminal VOUT1 via the resistor R21, but is otherwise basically similar to the semiconductor device 2A.

When a current flows through the coil 3 while both the high-side switch 24 and the low-side switch 25 are OFF, a current having a value equal to that of the current flowing through the coil 3 flows through a parasitic diode of the high-side switch 24. Therefore, when a current flows through the coil 3 while both the high-side switch 24 and the low-side switch 25 are OFF, the potential difference across the high-side switch 24 and the potential difference across the coil 3 are proportional to each other.

In the step-up DC/DC converter 1C according to the third embodiment illustrated in FIG. 4, the potential difference across the coil 3 can be indirectly detected by detecting the potential difference across the high-side switch 24.

By setting the resistance value of the resistor R21 and the current value of the constant current output from the constant-current source A21 to a value obtained by taking into consideration a threshold value and a proportional relation described above, it becomes possible for the voltage monitoring circuit 21 to output an abnormal voltage notification signal when the potential difference across the coil 3 exceeds the threshold value in the step-up DC/DC converter 1C according to the third embodiment as well.

### Additional Notes

Additional notes are provided for the present disclosure, the specific configuration examples of which are illustrated in the above-mentioned embodiments.

### (Additional Note 1)

A step-up DC/DC converter including:
an input line (LN1) configured to allow an input power supply voltage (Vin) to be applied thereto;
an output line (LN2) configured to allow an output voltage (Vout) to be applied thereto;
a coil (3) connected between the input line (LN1) and the output line (LN2);
a load switch (4) connected between the input line (LN1) and the output line (LN2); and
a semiconductor device (2A), in which
the semiconductor device (2A) includes
   a voltage monitoring circuit (21) configured to output an abnormal voltage notification signal when a potential difference across the coil (3) exceeds a threshold value,
   a control circuit (22) configured to control the load switch (4), based on the abnormal voltage notification signal, and
   a current control circuit (23) configured to control a current flowing through the coil (3) so as to match the output voltage (Vout) with a target value.

### (Additional Note 2)

The step-up DC/DC converter according to Additional Note 1, in which
the voltage monitoring circuit (21) includes
   a voltage drop circuit configured to generate a second voltage that is lower than a first voltage applied to a first end of the coil (3) by the threshold value, and
   a comparator (CMP21) configured to compare the second voltage with a third voltage applied to a second end of the coil (3), and
the first end of the coil (3) is connected to the input line (LN1) without passing through the second end of the coil (3), and
the second end of the coil (3) is connected to the input line (LN1) via the first end of the coil (3).

### (Additional Note 3)

The step-up DC/DC converter according to Additional Note 1 or Additional Note 2, in which
the control circuit (22) includes
   a logic circuit (221) configured to generate a switch drive signal, based on the abnormal voltage notification signal, and
   a switch drive circuit (222) configured to control the load switch (4), based on the switch drive signal.

### (Additional Note 4)

The step-up DC/DC converter according to Additional Note 3, in which
the logic circuit (221) and the switch drive circuit (222) are configured to use the input power supply voltage (Vin) as a power supply voltage.

### (Additional Note 5)

The step-up DC/DC converter according to any one of Additional Note 1 to Additional Note 4, in which
the control circuit (22) takes control to turn the load switch (4) OFF in response to the abnormal voltage notification signal, and then maintains the load switch (4) in the OFF state.

### (Additional Note 6)

The step-up DC/DC converter according to any one of Additional Note 1 to Additional Note 5, in which
the voltage monitoring circuit (21) includes a non-volatile memory (224), and
the step-up DC/DC converter adjusts the threshold value by a setting value stored in the non-volatile memory (224).

### (Additional Note 7)

The step-up DC/DC converter according to any one of Additional Note 1 to Additional Note 6, in which
the load switch (4) is provided between the input line (LN1) and the coil (3).

### (Additional Note 8)

The step-up DC/DC converter according to any one of Additional Note 1 to Additional Note 7, in which
the current control circuit (23) is configured to use a voltage applied to a connection node between the load switch (4) and the coil (3) as a power supply voltage.

### (Additional Note 9)

A semiconductor device that is a component of a step-up DC/DC converter including
an input line (LN1) configured to allow an input power supply voltage (Vin) to be applied thereto,
an output line (LN2) configured to allow an output voltage (Vout) to be applied thereto,
a coil (3) connected between the input line (LN1) and the output line (LN2), and
a load switch (4) connected between the input line (LN1) and the coil (3),
the semiconductor device including:
a voltage monitoring circuit (21) configured to output an abnormal voltage notification signal when a potential difference across the coil (3) exceeds a threshold value;
a control circuit (22) configured to control the load switch (4), based on the abnormal voltage notification signal; and
a current control circuit (23) configured to control a current flowing through the coil (3) so as to match the output voltage (Vout) with a target value.

### (Additional Note 10)

A semiconductor device including:
a first terminal (PVIN) connected to a first end of a coil (3);
a second terminal (SW) connected to a second end of the coil (3);
a third terminal (GC) connected to a control end of a load switch (4);
a voltage monitoring circuit (21) configured to receive a voltage applied to the first terminal (PVIN) and a voltage applied to the second terminal (SW), and to output an abnormal voltage notification signal when a potential difference across the coil (3) exceeds a threshold value;
a control circuit (22) configured to output a control signal for controlling the load switch (4) to the third terminal (GC), based on the abnormal voltage notification signal; and
a current control circuit (23) configured to control a current flowing through the coil (3).

It should be understood by those skilled in the art that various modifications, combinations, sub-combinations and alterations may occur depending on design requirements and other factors insofar as they are within the scope of the appended claims or the equivalents thereof.

What is claimed is:

1. A step-up direct current/direct current converter comprising:
an input line configured to allow an input power supply voltage to be applied thereto;
an output line configured to allow an output voltage to be applied thereto;
a coil connected between the input line and the output line;
a load switch connected between the input line and the output line; and
a semiconductor device, wherein
the semiconductor device includes
a voltage monitoring circuit configured to output an abnormal voltage notification signal when a potential difference across the coil exceeds a threshold value,
a control circuit configured to control the load switch, based on the abnormal voltage notification signal, and
a current control circuit configured to control a current flowing through the coil so as to match the output voltage with a target value.

2. The step-up direct current/direct current converter according to claim 1, wherein
the voltage monitoring circuit includes
a voltage drop circuit configured to generate a second voltage that is lower than a first voltage applied to a first end of the coil by the threshold value, and
a comparator configured to compare the second voltage with a third voltage applied to a second end of the coil, and
the first end of the coil is connected to the input line without passing through the second end of the coil, and
the second end of the coil is connected to the input line via the first end of the coil.

3. The step-up direct current/direct current converter according to claim 1, wherein
the control circuit includes
a logic circuit configured to generate a switch drive signal, based on the abnormal voltage notification signal, and
a switch drive circuit configured to control the load switch, based on the switch drive signal.

4. The step-up direct current/direct current converter according to claim 3, wherein
the logic circuit and the switch drive circuit are configured to use the input power supply voltage as a power supply voltage.

5. The step-up direct current/direct current converter according to claim 1, wherein
the control circuit takes control to turn the load switch OFF in response to the abnormal voltage notification signal, and then maintains the load switch in the OFF state.

6. The step-up direct current/direct current converter according to claim 1, wherein
the voltage monitoring circuit includes a non-volatile memory, and
the step-up direct current/direct current converter adjusts the threshold value by a setting value stored in the non-volatile memory.

7. The step-up direct current/direct current converter according to claim 1, wherein
the load switch is provided between the input line and the coil.

8. The step-up direct current/direct current converter according to claim 1, wherein
the current control circuit is configured to use a voltage applied to a connection node between the load switch and the coil as a power supply voltage.

9. A semiconductor device that is a component of a step-up direct current/direct current converter including
an input line configured to allow an input power supply voltage to be applied thereto,
an output line configured to allow an output voltage to be applied thereto,
a coil connected between the input line and the output line, and
a load switch connected between the input line and the coil,
the semiconductor device comprising:
a voltage monitoring circuit configured to output an abnormal voltage notification signal when a potential difference across the coil exceeds a threshold value;
a control circuit configured to control the load switch, based on the abnormal voltage notification signal; and
a current control circuit configured to control a current flowing through the coil so as to match the output voltage with a target value.

10. A semiconductor device comprising:
a first terminal connected to a first end of a coil;
a second terminal connected to a second end of the coil;
a third terminal connected to a control end of a load switch;
a voltage monitoring circuit configured to receive a voltage applied to the first terminal and a voltage applied to the second terminal, and to output an abnormal voltage notification signal when a potential difference across the coil exceeds a threshold value;
a control circuit configured to output a control signal for controlling the load switch to the third terminal, based on the abnormal voltage notification signal; and
a current control circuit configured to control a current flowing through the coil.
